(19) United States
(12) Patent Application Publication
(10) Pub. No.: US 2009/0188466 A1
(43) Pub. Date: Jul. 30, 2009

(54) Hybrid piston/rotary engine

(76) Inventor: William Scott Wiens, Pompano Beach, FL (US)

Correspondence Address: WILLIAM S. WIENS, 1001 S. RIVERSIDE DR #103, POMPANO BEACH, FL, 33062, US

(21) Appl. No.: 12/011,107

(22) Filed: Jan. 24, 2008

(51) Int. Cl. F02B 57/00

(52) U.S. Cl. 123/244

(57) ABSTRACT

A Hybrid Piston/Rotary engine having an elliptical housing comprising a circumscribed cam portion to provide thrust, and sides having bearing supports for rotation of a rotor with at least one cylinder attaching shaft having apertures therein, providing rotary valves combined with intake and exhaust ports within the bearing supports. Each cylinder has two opposed pistons connecting cam followers pivoted to the rotor which reciprocate upon rotation. During the intake stroke the pistons separate as intake valve opens, fuel mixture fills the cylinder and closes, the pistons compress the mixture. The rotor ports are aligned with the spark plugs within the bearing supports. Ignited gasses force the pistons apart causing the cam followers to push against the cam housing providing thrust to the rotor. The exhaust valve is opened as the pistons contract. Four strokes are completed each rotation. The mechanisms valves can be configured as a pump or a motor.

### BACKGROUND

1. Field of Invention

The present invention relates to rotary engines as well as conventional piston engines having beneficial aspects of both. A hybrid combination of novel features fundamentally operate as an Atkinson cycle four stroke utilizing the advantages of the Junkers opposed piston design. Similarly this design employs rotary valves, reminiscent of the Wankel, thus reducing frictional and dimensional complexities. By providing a more efficient mechanism than the crankshaft, the present composition achieves the best attributes of these previous designs, being greater than the sum of its parts.

2. Description of the Prior Art

Most conventional internal combustion engines utilize a crankshaft to convert reciprocating piston motion into rotary motion. Also known as the crank-slider mechanism which had been commonly used prior to the advent of steam engines. The crank mechanism provided mobility to bicycles, spawned the industrial revolution as perfected by James Watt in the steam engine, and later propelled the automobile in the Otto cycle engine. Further developed by Lanchester, Daimler, Lenoir, and a host of well known and legions of unknown contributors in which a library of devoted gratitude is espoused.

There are certain kinematic limitation to the crank mechanism. At the top and bottom segments of each stroke there is reduced leverage to perform work. There is no leverage at top dead center (TDC). As the crankshaft rotates from TDC, leverage increases from 0 to its maximum leverage near 90 degrees. This area of maximum leverage is the “sweet spot” where most of the work is performed. Then toward the bottom of the stroke leverage is again progressively diminished. Under load, at lower engine speeds, combustion forces are constrained causing cylinder pressures to increase (spike) which can produce a pinging sound (knock) that will lead to engine destruction. Higher octane fuels are commonly used to retard combustion thus counteracting the moment of leverage until leverage is available.

The present invention provides a mechanism which produces a contiguous progression of leverage due to it's mechanical linkage. Piston movement is continuous and more sinusoidal having less dwell at TDC and BDC. A larger torque arm provides more leverage to perform work producing a wider sweet spot. Also being a more balanced and efficient means of converting reciprocating motion into rotary motion than the crankshaft.

Various forms of the Otto cycle engine, derived from the same crank-slider mechanism have resulted in increased mechanical efficiency. The Diesel cycle engine utilizes a higher compression ratio to operate on low quality fuel which is harder to ignite but has a higher energy content. Highly compressed air ignites the fuel as it is injected into the cylinder at TDC which is known as compression ignition. The low quality fuel which we know today as diesel fuel is used primarily however other fuels such as peanut, vegetable, soy, etc. (bio-diesel oil) and coal oil have been common fuel substitutes.

Another variation of the crank-slider is the Atkinson cycle engine which increases mechanical efficiency by providing expanded strokes. A separate link between the crankshaft and the connecting rod varies the length of certain strokes, adjacent to less critical strokes, producing an increased ratio of efficiency. (i.e.; the intake stroke is longer than the compression stroke and the adjoining power stroke is longer than the exhaust stroke.) This has a supercharging effect without extraneous mechanical complexity.

An opposed piston design pre-dating WWII by Hugo Junkers operating as a diesel 2-cycle engine proved the benefits of eliminating the cylinder heads, which were prone to crack and even today are a substantial cause of engine failure. Having opposed pistons reduces heat transfer and permits much higher operating temperatures and pressures than otherwise possible. Each piston is connected to separate crankshafts and synchronized slightly out of phase to allow scavenging through intake and exhaust ports in the common cylinder. Additional benefits of the opposed piston (O-P) design is that for an equal rate of compression and expansion, the piston speed is only half that of a single piston acting against a fixed cylinder head. The forces of combustion are transferred equally through opposed pistons and more closely duplicates the natural model of combustion (equilateral pressures force the pistons apart in both directions also the flame front does not have to travel as far down the cylinder). The main bearings, piston pins, connecting rods, and associated parts absorb fewer stresses from combustion related forces which are usually transmitted between the crankshaft and cylinder head in conventional engines (unbalanced dynamic forces are much lower). The Junkers O-P design proved the ability to tolerate compression pressures and temperatures far exceeding those of conventional engines without harmful effects and could readily ignite tar oils (operate with low quality fuels and achieve good fuel economy). Other opposed piston designs have also proved these beneficial attributes.

The Hybrid Piston/Rotary engine as disclosed provides similar mechanical advantages to these previous designs without the mechanical complexities while reducing the number of parts and is more compact.

There are other variations of the crank-slider which use an alternate mechanism or linkage to modify it's inherently deficient characteristics. The Gomecsys and Mayflower engines offer a novel but complicated approach in varying compression and extending strokes. Another design, SAAB VC provides variable compression by altering the height from the crankcase by pivoting the cylinder to change the overall compression height.

Other variations providing an alternative mechanism to the crank-slider are the Scotch yoke mechanism (Bourke engine). This mechanism increases dwell time at TDC and BDC which is thought to increase mechanical efficiency. There are two schools of thought as to which is preferable. To dwell or not to dwell. Another is the Geneva stop (Maltese cross) mechanism as well as the swash plate mechanism. None of these contrivances are in wide use today or had any success in engines.

The Wankel rotary engine is a significant departure from convention which has a triangular rotor and elliptical housing instead of pistons and a traditional cylinder. It utilizes a simplified rotary valve which reduces parasitic frictional losses and permits higher rewing output while providing all four strokes in a single rotation of the takeoff shaft. Instead of a crankshaft, a three lobed rotor oscillates trichoidally to forcibly gyrate an eccentric shaft which is the power shaft. Low torque, high emission and fuel consumption are areas of ongoing development.

The Hybrid Piston/Rotary engine utilizes a rotary valve similar to the Wankel rotary engine. It provides four distinct strokes every revolution of the rotor shaft and is ostensive similar. Instead of a crankshaft the present design incorporates a rotating cylinder block bisected lonitudally by a shaft which employs two diametrically opposed pistons. The static air/fuel mixture is radically mixed as it enters the rapidly spinning rotor enhancing thorough combustion. Each piston stroke is half the length of a conventional layout while producing an equivalent stroke. Cylinder pressures are shared equally by both pistons. The present design achieves the objective benefits of past engine designs by increasing mechanical efficiency. It provides a much simpler mechanism operating with fewer parts, necessitating a smaller overall design footprint.

### OBJECTS AND ADVANTAGES

An objective of the present invention is to provide a hybrid engine design that shares the clean combustion attributes of the 4-stroke Otto cycle piston engine. With increased turbulence to promote more thorough combustion and cleaner emissions.

And also to provide an increase in mechanical efficiency as the Atkinson cycle engine, by providing expanded strokes for the intake and power strokes. Having a supercharging effect without extraneous parasitic means.

And being compact and less complicated as the Wankel rotary engine with a power stroke every revolution of the rotor shaft thus providing greater power density.

It is another object to provide a rotary valve which reduces frictional losses and simplifies operation while significantly reducing intricate parts. To easily provide an intake, exhaust, and spark plug on each side of the rotor cylinder as well as a pre-chamber where combustion is initiated within the cylinder.

It is yet another object of the present invention to provide an engine with superior torque characteristics as well as the capability to operate at high RPM's having inherently balanced characteristics.

Another objective of the present invention is to provide an alternative to the crankshaft mechanism which eliminates the need for a cylinder head and utilizes a less complicated mechanism with two pistons per cylinder to better distribute power. Producing continuous leverage and having a greater torque arm, there is a larger sweet spot to provide useful power.

It is a further objective of the present invention embedded within the scope of embodiments, the ability to be configured as a pump for compressing and moving working fluids, (liquids or gasses) as well as the capacity to be arranged as a motor powered by liquids or gasses (example—air compressor, steam engine, hydraulic pump, hydraulic motor, etc.). By changing the position of the intake and exhaust ports of the present invention, it is easily adaptable and for such applications other embodiments are provided. As such, each rotation of the rotor produces two distinct pumping cycles, two intakes strokes and two exhaust strokes.

It is a considerable delineation of the present invention to provide means to alter the compression within the cylinder as necessary and/or provide variable valve timing.

Substantially it is purposed that the geometric variance of possible configurations can be tailored to specific applications as necessary and is described specifically.

### SUMMARY OF THE INVENTION

A Hybrid Piston/Rotary engine is disclosed which shares the functions and many of the properties of a conventional Otto cycle piston engine as well as those of a rotary engine. Being similar in appearance to a Wankel rotary engine, an external housing is elliptically shaped and performs as a cam to provide thrust from an enclosed rotor, which is supported for rotation therein. Instead of a conventional crankshaft, the rotor is comprised of a cylinder (or cylinders) connected to a shaft which rotates within bearing surfaces and supported by the housing. The rotor cylinder contains two opposed pistons which work in reverse direction of each other. There is no conventional cylinder head as each piston is effectively the cylinder head of the opposing piston. Compression is contained between them as well as expansive forces thrust against both pistons pushing them apart. Each piston is connected to a respective cam follower assembly by a connecting rod. Each cam follower is pivotally attached on opposite sides of the rotor and at opposite ends of each cam follower are mounted rollers. Upon rotation of the rotor, the cam follower rollers follow the curvature of the elliptically shaped housing, causing them to reciprocate according to the contour of the housing. The connected pistons are caused to reciprocate accordingly. For each rotation of the rotor shaft the pistons are forced together and apart twice. Essentially, when the pistons are not moving together, they are moving apart and cannot remain motionless due to their geometric relation to the cam housing. Because both pistons move in opposite directions and transfer torque equally to the inner circumference of the cam housing this provides a larger torque arm, or area where the piston can provide thrust. There is a larger sweet spot as this mechanism continuously produces leverage invariably and translates a sinusoidal motion to the pistons. Combustion pressures are transferred equally between the opposed pistons, forcing them apart and more closely duplicates the natural model of combustion. Combustion propagates from the center and the flame front does not travel as far down the cylinder. The pistons, pins, connecting rods, cam followers and related parts absorb half the combustion related stress of a conventional engine. Unbalanced dynamic forces are also much lower as pressure is exerted equilaterally to both sides of the cam housing distributing a balanced inertial mass in diametric proportions. Secondary imbalances are less problematic. Multiple cylinder configurations are staggered according to conventional means and all existing methods for piston engine technologies carry over readily to this design. It is a proven quantity.

Each rotor shaft includes a port aperture positioned in the center of the cylinder and extends through the rotor shaft journals to form a rotor port. As the shaft rotates, the port comes in alignment with corresponding ports in the bearing supports allowing them to effectively open and close as a rotary valve. The bearing supports have an intake and an exhaust port coupled to their appropriate manifolds. Single port arrangements are also effective where an intake rotary valve is on one side of the cylinder rotor and an exhaust rotary valve is on the other; or arranged with both ports on one side. This arrangement reduces the expense of providing dual fuel induction and exhaust convention. Each rotor shaft bearing support (valve/bearing) achieves multiple purposes; 1) to provide rotational bearing support for the rotor; 2) to function as a rotary valve for allowing working fluids to flow into and out of the attached cylinder; 3) to provide a spark plug situated in a position to initiate combustion as the rotor port comes in alignment with it at TDC (or fuel injector for diesel variants of the engine); 4) it functions as a breech or opening within the combustion chamber. Each rotor shaft port aperture is in fact a combustion pre-chamber in which combustion is initiated and propagates to the rotor cylinder as the pistons are caused to retract; and 5) to provide cooling elements within or around the rotary valve to lower operating temperatures as necessary. Hereafter this member will be referred to as the valve/bearing. Whereby each revolution of the rotor produces four distinct strokes providing power to the rotor.

The 4 stroke cycle of the present invention consists of; (1)The intake stroke begins with the pistons constricted and the rotor shaft port is rotating into alignment with the intake port on the valve/bearing, opening the intake port accordingly. The pistons are caused to retract apart as the connected cam followers move within the elliptical contour of the cam housing. This draws in an air-fuel mixture and the port is closed accordingly at the end of the intake cycle. The cam followers being pivoted to the rotor and connected to the pistons, are not fully contracted until approximately 100 degrees of rotation. (2)The pistons then compress the mixture as the cam followers cause the pistons to contract upon rotation. After approximately 80 degrees of rotation they have reached maximum assent within the cylinder, and the rotor shaft port is in alignment with the spark plug within the valve/bearing. The spark plug is caused to fire. (3)The compressed mixture is ignited just before 180 degrees of rotation and combustion occurs. The expansion of the contained gasses force the pistons apart causing the cam followers to reciprocate and provide thrust against the cam housing, transmitting power and rotation to the rotor shaft. The power stroke is permitted a proportionately longer interval of 100 degrees to capture expanding gasses and produce more complete combustion. (4) At the end of the power stroke (approx 280 degrees), the exhaust valve is effectively opened as the pistons are contracted, forcing exhaust gasses from the cylinder and is closed after 360 degrees of rotation. Hence, the pistons have retracted and contracted twice, and all 4 strokes have been completed in a single rotation. Each cylinder can be provided with one rotary valve per side or two valves per side, which is the preferred embodiment. This arrangement allows for two intake valves, two exhaust valves, and two spark plugs per cylinder. Also the rotor shaft can have be arranged with a series of multiple cylinders, as required. The geometric length of the expanded stroke can be altered to a specific range of parameters as necessary for any particular application and a wide variety of cam housing contours can be considered to produce a desired ratio. The aspect ratio as well as the rod/stroke ratio need to be determined for specific applications.

Similar to a Wankel rotary engine, a power stroke is produced each revolution of the rotor shaft and frictional losses from rotary valve actuation has very little parasitic loss. Unlike the Wankel, there is no overlapping of strokes where exhaust gasses can mix with the intake mixture because the valves are completely closed from one stroke to the next, negating possible backfire.

The Atkinson cycle engine provides a crankshaft linkage which produces a longer expansion stroke and intake stroke. This is known to produce greater mechanical efficiency. However the mechanical complexities and space requirements have been constraints for this design. The present invention is an Atkinson cycle engine according to every definition, and provides a simpler, more efficient mechanism, with fewer parts, and is smaller in size.

The variation between the length of these strokes is the result of a simplified mechanical linkage. Also the connecting rods are attached to their respective cam followers at a position having a greater radius from its pivot point than the followers contact point on the cam surface. The pistons are caused to move further than their respective rollers by virtue of this increased radius as positioned on the cam followers. This increased radius can be modified to increase or decrease the effective compression ratio. This can be beneficial in controlling the burn rate of specific fuels for various operating parameters. This will be described in further detail in the drawing specifications.

Valve Operation—The conventional four stroke piston engine utilizes poppet valves which are opened by a camshaft and caused to close by valve springs. The tension of the springs has to be sufficiently stout enough to force them to close before the piston reaches the top of the next stroke, critical at high operating speeds. According to industry sources valve train operation consumes 20% of an engines power at low speeds with at least 10% frictional losses at higher revs. Performance oriented engines have double springs with four valves per cylinder. With the addition of VVT (variable valve timing) and intricate computer interfacing this arrangement is complicated and expensive with the result of having a lot of moving parts and significant friction. This part of the engine which pertains to the operation of the valves including sprockets, chains, tensioners, cams, etc. are part of the valve train.

Wankel type rotary engines utilize rotary valves which open and close as the rotor slides past the intake and exhaust ports. This sliding motion is almost effortless and is a considerable benefit to the engines ability to rev at RPM's beyond most production engines. This rotary valve is simple, efficient, and performs very well making it a prominent feature of this design. Yet, the ever changing shape of the combustion chamber which is formed relative to the movement of the rotor, causes an elongated irregular combustion chamber shape that is less conducive to enabling the transport of chemical reactants involved in the combustion process. (I.e.—a round cylinder has better sealing characteristics, also it is an ideal shape to access the explosive forces and transport of deflagration.) The trichoidal motion of the rotor allows three phases of 4-stroke combustion process to take place simultaneously, at various stages. Consequently some of these strokes overlap and insufficient port valve separation have been the cause of excessive emissions and fuel consumption. New design configurations have addressed some of these problem and may have improved the conditions. Inherently, a three sided rotor producing four strokes will mathematically always leave some overlap.

The rotary valve in the present invention requires very little effort to operate as the bearing and the valve are the same component. Valve/bearing friction is fractional and the bearing surfaces can be lined with polymeric coatings or other low friction materials as well. Other engine components as well can benefit from non-traditional techniques to further enhance efficiency. The volume and size of the rotary valve can be increased to increase flow by increasing the diameter of the rotor shaft and port opening. The duration interval, which the valve remains opened, equals the length of rotation from the beginning of the stroke to the end of the stroke, divided by 2. This defines the necessary width (radially) of the port aperture on the rotor shaft and on the valve/bearing. The size of the port aperture can also be lengthened (axially) to increase volume. This can be done without effecting the opening or closing event of the valve. Also as it can be appreciated, the rotor port aperture works in unison with the intake and exhaust port apertures on the valve/bearing to form the respective rotary valves. As the intake stroke is proportionately longer than the exhaust stroke, the width of these port apertures will need to be balanced to provide the best operating characteristics suitable for a given application. The flow and volume of the port apertures need to be balanced with regard to its volume as a pre-chamber.

The rotor port apertures connecting the cylinder are part of the combustion chamber (on both sides), and they function as pre-chambers for combustion. Each pre-chamber has its own spark plug provided on the valve/bearing for spark ignited variations and separate injectors for diesel variants. On variations of the engine which include an intake and exhaust valve on each side of the cylinder, it is possible to allow a lean mixture on one side of the cylinder and a rich mixture on the other. Also, altering valve timing by rotating the valve/bearings radially from one side opposite the other will change combustion characteristics to facilitate heavy load conditions or high RPM, as necessary.

The larger sweet spot of the present mechanism is less sensitive to spark advance in ignition timing because there in little dwell near TDC. Conventional crankshaft engines are more dependant on spark advance to time the precise downward movement of the piston because there is diminished crank movement and leverage in the crank-slider mechanism. Areas of engine function which have been critical to achieve maximum performance are not relevant to the present design which provides a mechanism which supersedes them.

Enhanced Combustion

A fuel mixture entering the cylinder of an engine during the intake stroke contains miniscule droplets of fuel that are not completely vaporized. It is well known that by increasing the turbulence within the cylinder improves the combustion process exponentially, similar in effect to that of a fire storm. This has a whirlwind effect of rapidly blending the numerous species of chemical reactions that take place in milliseconds upon combustion. It is an area of extensive laboratory research to break the code of understanding these molecular reactions. The chemical kinetics model code, known as HCT (Hydrodynamics, Chemistry, and Transport), are factors which effect the combustion process and the by-products of emissions they produce. Ideal combustion is an underlying derivative of increased turbulence.

The present invention significantly increased turbulence by virtue of its kinetic induction characteristics. The intake charge enters the intake port into the cylinder with increased velocity. The rotational speed of the rotor in relation to the stationary intake port causes radical swirl. As rotor speed is increased, the velocity of swirl is proportionately extreme due to the kinetic variance. An object in motion (incoming fuel mixture) is coming in contact with another object in motion (rotating cylinder) at diverging vectors which produces radical turbulence. Furthermore, each cylinder has ports on opposite sides and there is a multi-directional tumble of gasses within the cylinder as the pistons retract in opposite direction. After the cylinder is filled, the pistons contract to compress the mixture for combustion. There is sufficient atomization and hyper-mixing of gasses which thoroughly combines the countless species of chemical reactants to formulate complete and clean combustion. Spark-ignited variants of the engine provide spark plugs in both valve/bearings and combustion propagates from opposite ends of the combustion chamber enhancing deflagration. Fuel injected and diesel variants are also enhanced.

Variable Displacement

Another formable feature of the present invention purposes a means to alter compression within the cylinder. There are numerous reasons why it is desirable to vary displacement and it is an area of extensive development. Engines having a higher compression ratio generally require higher octane fuels to mitigate knock or auto-ignition. Under most engine operating conditions, lower octane fuels perform equally well except during heavy load conditions where knock can occur and it is essential to lower compression. Having the ability to alter compression enables an engine to also utilize various fuels which have different flash points. An area of intense research pertains to an engine concept known as HCCI (Homogenous Charge Compression Ignition) which unlike spark-ignition and compression-ignition, the homogenous fuel mixture is auto-ignited by compression. Also referred to as CAI (Controlled Auto Ignition) where a lean mixture is compressed to the point that it combusts precisely at the top of the stroke. It is predicted that variable displacement is crucial in controlling the precise event of combustion to operate under various load conditions. With HCCI exhaust emissions are reduced and almost eliminated, for this reason it is being investigated with great prospect and vigor.

### BRIEF DESCRIPTION OF DRAWINGS

FIG. 1 shows an exploded isometric view of the components in the preferred embodiment where an intake and exhaust are provided on each side of the rotor (an arrow designates direction of movement or flow).

FIG. 2 shows an exploded perspective view of the pump/motor arrangement of the same mechanism with valve/bearing # VB1 that are both intake ports and the valve/bearing # VB2 that provides both exhaust ports, no spark plugs are present in this configuration.

FIG. 3A, 3B, and 3C shows three different views of the rotary valve in detail for the two port configuration of the valve/bearing. Providing an intake, an exhaust, and a spark plug on each valve/bearing. Also valve advance is shown in slotted holes for slidable rotation The arrows show direction of flow. The single port, double port, and pump arrangement (except spark plug) all sharing the same elements and working relation with each other.

FIG. 4 (suffix A thru H)—8 figures outlining the sequence in motion of the four stroke cycle over the span of 360 degrees (in 45 degree intervals).

FIG. 5 show a view of the single port valve/bearing. And the rotor is stripped down without; divider partitions, pistons and the attached cam follower assemblies, or pins. Also is removed for clarification is the housing and all of its elements. The rotor is shown in the intake open position which is also shown in the FIG. 4B.

FIG. 6 shows the same view of the single port valve/bearing shown in the position of FIG. 4C. Removed for clarification is the housing and all of its elements.

FIG. 7 is a chart showing the comparison of piston movement per degrees of rotation. The crankshaft engine VS the hybrid piston/rotary engine.

FIG. 8A, 8B, and 8C show how elements of the mechanism are to be altered to vary compression within the cylinder (lines indicate directional movement of components).

### DESCRIPTION OF THE PREFERRED EMBODIMENT

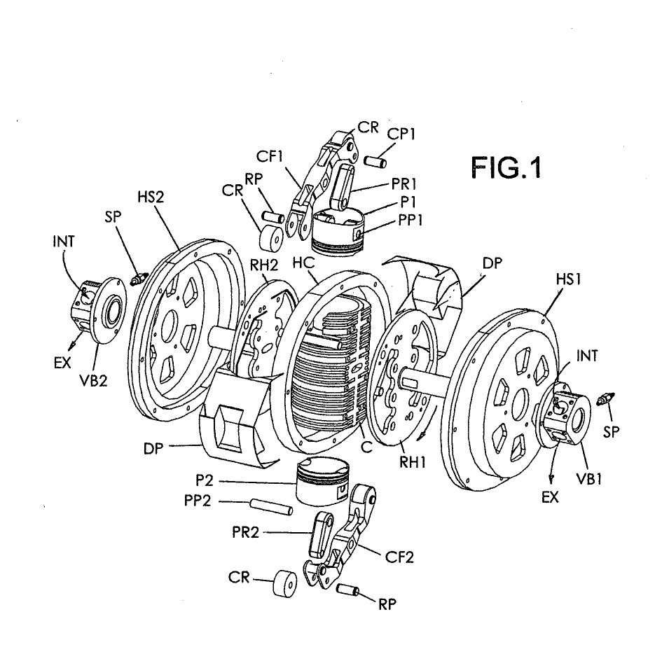

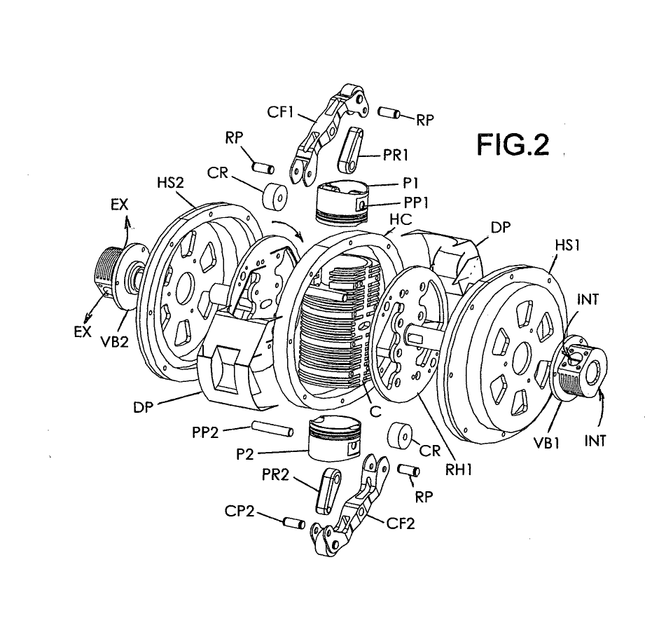

Referring to the drawings, the present invention is disclosed in FIG. 1 (which is shown with dual intake and dual exhaust valves), also shown in FIG. 2, as a different configuration in which the same mechanism has valve/bearings with port openings arranged as a pump/motor configuration. Two intake and two exhaust strokes are produced twice (providing two pumping cycles) each revolution.

In FIG. 1, the engine/pump/motor mechanism is shown in which a rotor # R, consisting of a cylinder # C, with attached rotor halves # RH1 and # RH2, having bisecting shafts extending as journals for rotation within a stationary housing assembly # H. The housing # H, is comprised of three sections; an elliptically shaped middle section or housing cam # HC, and two exterior housing sides # HS1 and # HS2, which provide support for valve/bearings # VB1 and # VB2 for rotational support of the rotor. Positioned within the cylinder # C are two opposed pistons # P1 and # P2, which face each other and being adjoined by piston pins # PP1 and # PP2, are connected to corresponding piston rods # PR1 and # PR2, positioned respectively. Two cam followers # CF1, and # CF2, are attached respectively to the piston rods by connecting pins # CP1 and # CP2. The cam followers are pivotally mounted to the rotor with follower pins # FP1, and # FP2. The cam followers each have two similar corresponding cam rollers # CR, fixed for rotation on opposite ends of their respective assembly by similar roller pins # RP, to communicate within the circumscribed interior of the housing cam # HC. As the rotor is caused to rotate within the housing, both cam follower assemblies # CF, are also caused to reciprocate their respective connected piston rods and pistons. The pistons retract and contract in opposite direction and between them is formed the combustion chamber # CC (not shown). Divider partitions # DP, are positioned between the rotor halves and cylinder to divide the interior air cooled section of the rotor from the oil lubricated exterior section of the rotor.

FIG. 2 represents the pump/motor embodiment of the mechanism with valve/bearing which provide two distinct pumping cycles per rotation. Each are comprised of two strokes, an intake of the working fluid and an exhaust of the working fluid. As such, the incoming fluid is provided a longer intake interval than the adjacent outgoing stroke. This allows a greater volume of fluid to be moved or compressed than a conventional mechanism with an equivalent displacement can achieve, as the result of its increased mechanical efficiency. The flow of fluid is from one side of the mechanism to the other making the respective manefolds simpler to arrange and connect.

### Description of the Preferred Embodiment

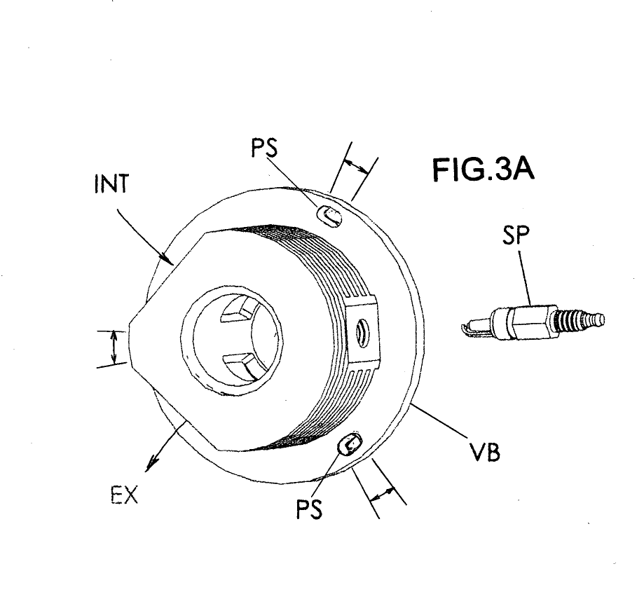

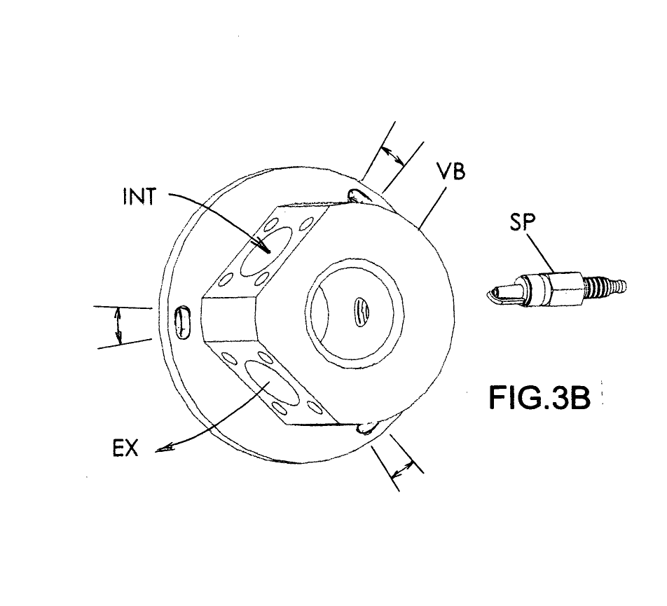

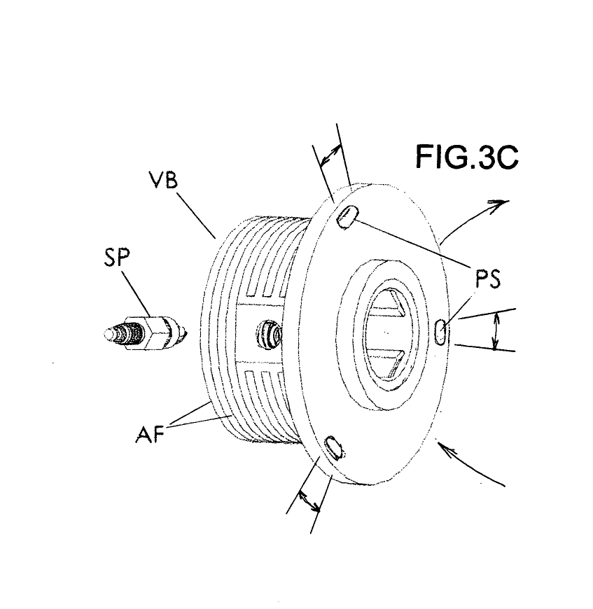

Shown in FIG. 3A thru 3C, are views of the rotary valve representing a view of the preferred embodiment and is shown having 2 intake and 2 exhaust ports, and a spark plug positioned on each valve/bearing which is the identical part for both sides. When the shaft aperture (not shown) comes in alignment with the intake port # INT, the intake valve is opened and, likewise, when the aperture is in alignment with the exhaust port # EX, the exhaust valve is opened. Also formed within each valve/bearing is a spark plug # SP, positioned in alignment with the shaft aperture. An appropriate ignition system (not shown) causes the spark plug to fire at the top of the compression stroke when the shaft aperture is in alignment and ignites the fuel mixture within the cylinder. For compression ignition configurations, a fuel injector would replace the spark plug location. Also not shown (though obvious) is the intake manifold which connects the port to appropriate means, either carburetor or fuel injector. An appropriate exhaust manifold connects the exhaust port in like manner as is apparent.

Also among the many functions of each valve/bearing is to provide cooling air fins # AF, which act as heat sinks to dissipate or accumulate heat. Cooling can be achieved through convection of air or liquid means. The valve/bearing in combination with the rotor shaft aperture form a breach where combustion is initiated and is also a pre-chamber to the attached cylinder. They are positioned on both sides of the cylinder providing twice the available volume for induction, propagation, and expulsion of fluids providing the cylinder throughout the four stroke cycle. The symmetry of this arrangement ensures thorough combustion and enhances the tumble, swirl, and radical turbulence essential for rapid reactivity.

Variable valve timing capabilities are also shown in FIG. 3A, 3B, and 3C. Under certain operating conditions it may be beneficial to vary valve timing by either advancing or retarding the interval which the valves are caused to open and close. The present invention provides means by which this is easily performed. Shown is the preferred embodiment of the engine valve bearing but is not limited to it, alone.

According to the drawings, FIG. 3A, 3B, and 3C shows the valve/bearing #VB, (both sides are identical, and will be referred to universally) consisting of port apertures for an intake # INT, and an exhaust # EX. The valve/bearings are slidably secured by pivot slots # PS, to their respective housing side # HS (not shown), allowing each to be rotated incrementally around the axis of the rotor shaft independent of each other. During some operating conditions these can be staggered, allowing one to overlap the position of the other or move together as necessary, to alter the sequence of valve timing. In effect providing an increased duration of valve overlap where one valve opens and closes proportionally before the other. Also shown is the spark plug # SP.

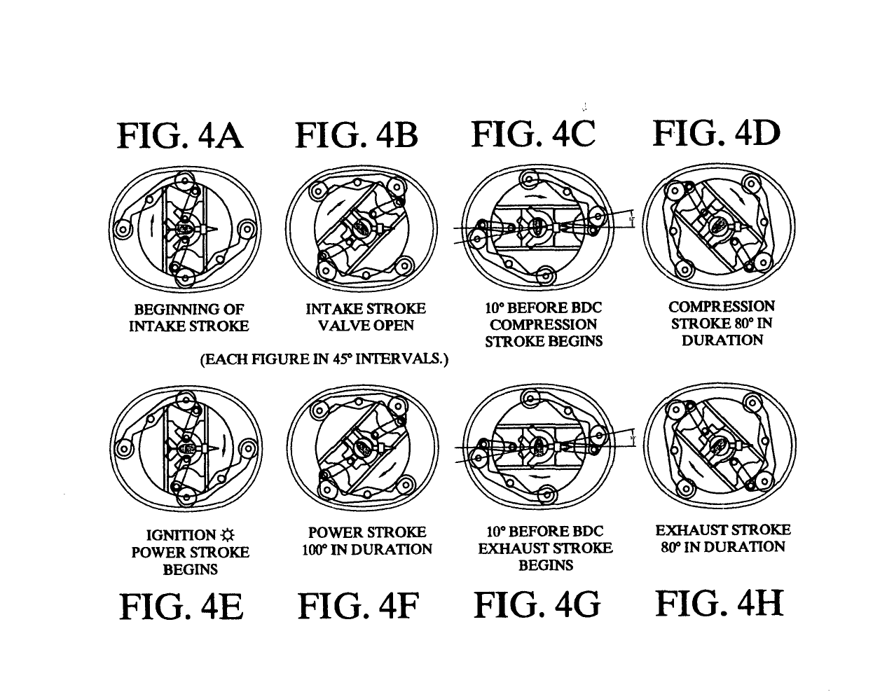

Referring to the drawings of FIG. 4, with suffix A thru H ; these 8 figures outline the sequence in motion of the four stroke cycle over the span of 360 degrees (in 45 degree intervals). FIG. 4A, Shows the beginning of the intake stroke. The rotor shaft port is coming into alignment with the intake port on the valve/bearing and the valve begins to open incrementally as the rotor is caused to rotate (arrow indicates direction). The cam followers are caused to reciprocate and their respective pistons retract, filling the cylinder. FIG. 4B, Almost half way through the intake stroke the intake valve is open and the fuel mixture is sucked into the cylinder. Until the rollers are situated on the corners of the cam housing, the pistons are still in motion. This cycle takes approximately 100 degree before the pistons are at BDC. FIG. 4C, The cylinder is shown at 90 degrees and after another 10 degrees of rotation the compression stroke begins. The pistons contract more rapidly than they expanded due to their mechanical linkage with the cam followers. FIG. 4D, The fuel mixture is compressed inwardly by continuous, simultaneous thrust from both pistons which after about 80 degrees of rotation reach TDC. FIG. 4E, Reveals a fully compressed intake charge where the cam rollers are on the corners of the cam housing and the pistons are fully contracted. The spark plug positioned within the valve/bearing is directly in aligned with the rotor shaft port and the spark plug is caused to ignite the mixture just prior to TDC. Combustion begins and expanding gasses rapidly force the pistons apart with intense velocity. FIG. 4F, Shows the power stroke after 45 degrees from TDC. The expansion stroke is providing a proportionately longer duration of 100 degrees to harness the power of combustion. FIG. 4G, After another 10 degrees of rotation, the pistons are fully retracted having an extended interval to provide work. The exhaust port is then allowed to open and exhaust gasses are rapidly expelled from the cylinder. This stroke is proportionally shorter being 80 degrees in duration. FIG. 4H—Shows the exhaust port in the fully opened position and the ascending pistons similarly cause exhaust gasses to be expelled from the cylinder during the remaining 45 degrees. The exhaust port is gradually caused to close toward the end of the stroke. Subsequently within 360 degrees all four strokes of the Atkinson and Otto cycle description are completed. Continuous cycles ensue providing a seamless supply of power as necessary.

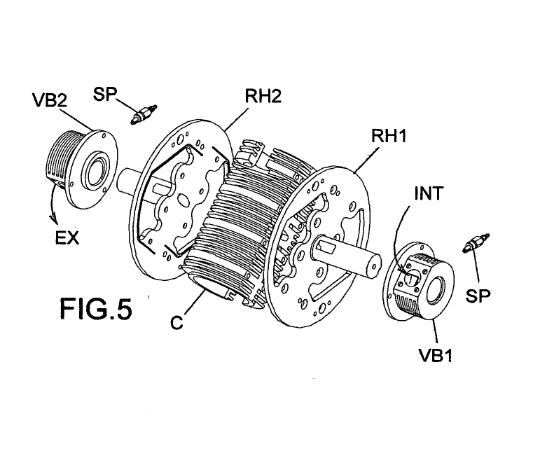

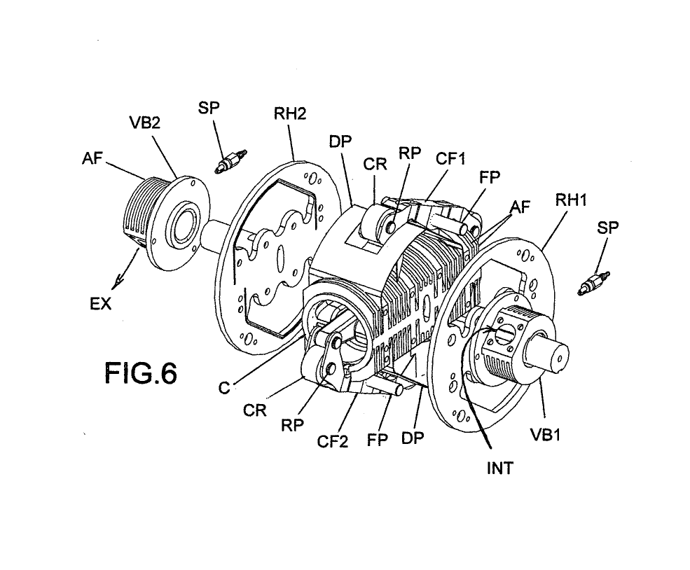

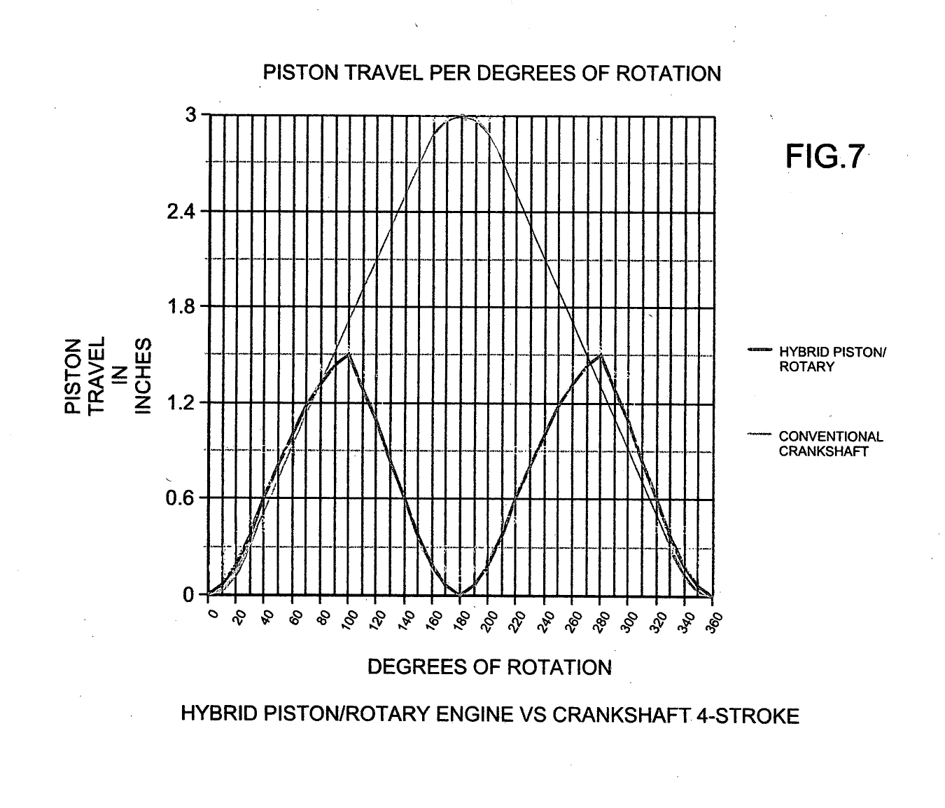

FIG. 5, and FIG. 6, are an alternative rendition of the patent which may be preferable in economies of scale and scope. Where lower output is appreciable, this arrangement provides one port valve # PV, and one spark plug #SP, on each valve/bearing # VB. Both valve/bearings on each side of the engine are identical. (So that the designation of intake port # INT, is being used on one side of the engine in the intake position, and that the identical part designated, exhaust port # EX, is being utilized on the opposite side the engine in the exhaust position) Its working relation is identical to FIG. # 3A, except that overall flow is from the intake side of the engine moving through to the exhaust side of the engine and are not flowing in unison as the preferred embodiment.

Engine cooling and oiling—Referring to FIG. 6, a cylinder # C, is centrally positioned on a rotor# R. Upon rotation this allows continuous movement of air to flow around and about its attached air fins # AF. Also positioned between rotor halves #RH1 and #RH2, are separator partitions # SP, which fit within grooved slots in the rotor halves and cylinder. These partitions separate the inner section of the rotor which is dedicated for air circulation dividing the outer periphery of the rotor where oil is contained for lubrication of the internal engine parts. Air is allowed to pass through appropriate air openings # AO, on both housing sides #HS. Air fins # AF, attached to the inner surface of the partitions move air directionally into and out of the engine housing. Flow can be restricted as necessary to thermostatically control temperature. This arrangement offers a self contained simplified means of air cooling the cylinder. An alternative liquid cooling means or a hybrid combination including oil are obviously considered.

Oil lubrication for the working parts of the rotor can be by conventional means by which a spray nozzles in the housing would provide a stream of lubrication as the rotor rotates within. Another is to provide pressure lubrication to parts of the bearing journals to be distributed through port holes in the rotor for the cylinder and cam followers to accept lubrication according to conventional means.

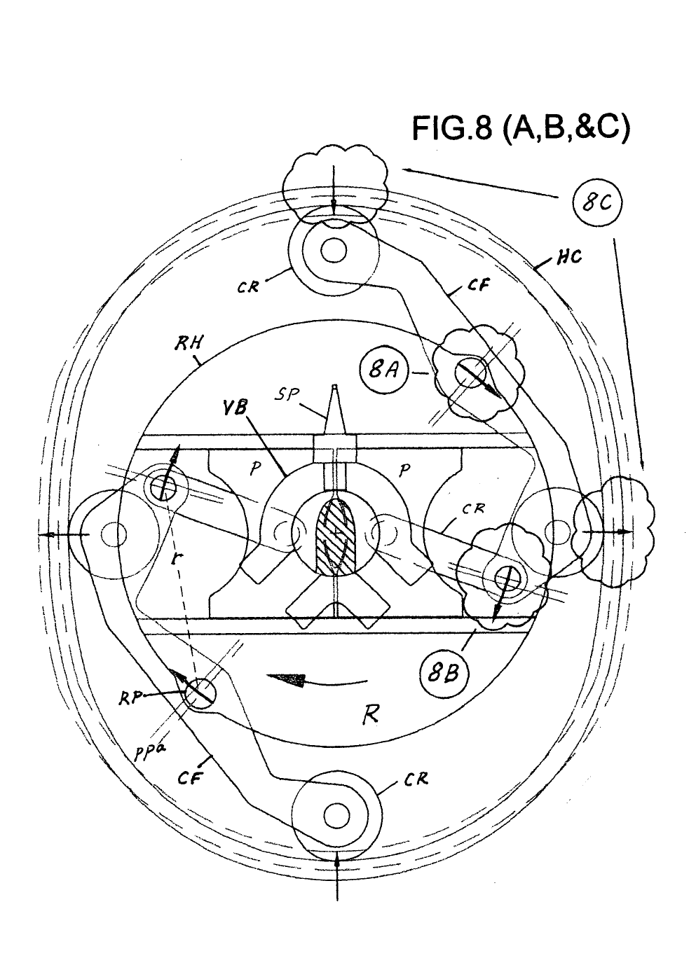

Variable Displacement—Means are envisioned in the present invention to after compression which are referred to in the drawings. FIG. 8A, 8B, and 8C. The cam followers # CF, are pivotally positioned by rotor pins #RP, on the rotor # R, and control the actuation of their respective pistons. By altering the position of the rotor pins proportionally along the radius of the rotor shaft in FIG. 8A, the linkage effecting the movement of the piston is altered. Moving the rotor pins respectively in the direction of the cylinder # C, effectively diminishes compression. Similarly, moving the rotor pins in the opposite direction effectually increases compression. Compression is defined by the volume between the pistons at top dead center, this is the area of the combustion chamber # CC. It is obvious to one skilled in the art, the ability to proportionately alter compression either by static adjustment or during engine operation. It should be understood that the rotor pins act as a pivot for the cam followers and do not bear the direct forces of combustion or compression. Wherefore the pins can be moved during engine operation without much torsional resistance. This can achieved by mechanical, hydraulic, or magnetic actuation.

Further means are envisioned in FIG. 8B, to alter compression by altering the pivot point connecting the piston rod # PR, on the cam follower # CF, moving the pivot toward the rotor pin # RP, for the respective cam follower, increases the compression and moving it away from the pin effectively diminishes compression respectively. Both sides of the rotor are uniformly moved in like fashion opposite each other.

Also shown in FIG. 8B, the connecting rods are attached to their respective cam followers # CF, at a position having a greater radius #r, from its pivot point # ppa, than the cam follower rollers # CR. The pistons are caused to move further from center than their respective rollers by virtue of this increased radius as positioned on the cam followers. FIG. 8A, shows the relationship of the pivot points # ppa, and their radius #r in respect to communicating motion from the housing cam # HC, to the pistons # P, and visa versa. Additional means in FIG. 8C, which constitutes the contortion of the housing cam # HC, to alter its' shape. Where the material comprising the housing cam would be sufficiently malleable enough to deform the major axis # MAJ, and minor axis # MIN, of the elliptic shape to make it incrementally conform through mechanical means to a shape which afters the compression height. One axis would decrease proportionally as the other axis increases. Both sides of the housing cam being moved in unison by hydraulic or mechanized actuation through servos. The possible scope of practical methods cannot be limited to one manifested device.

It is best shown in FIG. 4 (A thru H), where the geometry which changes the duration (or length) of each respective stroke is related. The intake stroke has an extended length of approx. 100 degrees with which to allow a fuel mixture to enter the cylinder. The shorter compression stroke (80 degrees in duration) circumvents heat transfer through the cylinder walls and pistons. The compression stroke is more rapid proportionally than the intake stroke and at TDC the rotor port aperture is in alignment with the spark plug which ignites the contained gasses initiating combustion within the cylinder. This forces the pistons apart causing the connected cam followers to apply motive force against the housing which transmits power to the rotor shaft. The power stroke is greater than the compression stroke providing increased mechanical efficiency. This allows a longer duration of approx. 100 degrees to convert combusting gasses into useful energy. In FIG. 4G, the pistons are almost at bottom stroke (BDC) and as they are caused to make their ascent, the exhaust port is opened to allow exhaust gas to vacate the cylinder and then closed at the end of it's 80 degree stroke. All four strokes occur within 360 degrees of rotation and produces one power stroke every revolution. Conventional 4 stroke Otto cycle engines require 720 degrees (2 revolutions).

The length of the stroke is in part due to the mechanical linkage of each connected piston rod # PR at an angle extending from the cam follower # CF beyond the connected cam rollers # CR, which define the peripheral limits of its circumscribed motion. This is best shown in FIG. 8A, The geometric link can be altered to effect the compression height which dictates the compression ratio, by moving the pivot point of the piston rod toward the cylinder # C, effectually decreases compression. In FIG. 8B, moving the pivot point #ppa, away from the cam follower will decrease the amount of compression. In FIG. 8C, the shape of the cam housing # CH, is changed to represent the broken line position in equal and opposite directions (the major axis of the ellipse is reduced while the minor axis of the ellipse is increased proportionately), to effectively reduce compression.

1) A mechanism or engine for providing power is claimed in which
a) a rotor comprising at least one cylinder which is bisected by a connected shaft perpendicular to at least one side axis of the cylinder to allow rotation.
b) said cylinder contains two opposing pistons sharing a common combustion chamber.
c) a housing, elliptical in shape having centrally positioned bearings on its side for rotational support of said rotor. The circumscribed interior of the elliptical housing acts as a cam to provide rigid support for thrust from the rotor.
d) connecting rods attach the pistons to respective cam followers which pivot on shafts positioned opposite each other on the rotor. The cam followers transfers piston motion to the cam housing. Motion is transmitted to the rotor.
e) pivotal support for cam followers causes their attached piston to reciprocate as the rotor is caused to rotate allowing two complete pumping cycles with a single rotation of the rotor shaft, providing four pumping strokes.

2) The engine according to claim 1, wherein are means to provide an air fuel mixture and spark apparatus for igniting said fuel mixture.

3) The engine according to claim 1, wherein are means to provide injected fuel charge for compression ignition.

4) The engine according to claim 1, wherein support bearings provide at least one valve to allow intake through openings in the rotor shaft and at least one exhaust to access the cylinder.

5) The engine according to claim 1, providing means to include rotary valves to provide an intake and discharge of the attached cylinder and further can be rotated to advance or retard valve timing accordingly.

6) The engine according to claim 1, wherein are means to vary compression by either static or dynamic means.

7) The engine according to claim 1, including means for cooling and lubricating said cylinder and working components.

8) A pump/motor is claimed for compressing or moving fluids (gasses or liquids) or for being driven by fluids in which
a) a rotor comprising at least one cylinder which is bisected by at least one shaft perpendicular to the axis of the cylinder to allow rotation.
b) said cylinder comprises two opposing pistons sharing a common combustion chamber.
c) a housing, elliptical in shape having centrally positioned bearings on its side for rotational support of said rotor. The circumscribed interior of the elliptical housing acts as a cam to provide rigid support for thrust from the rotor.
d) connecting rods attach the pistons to respective cam followers which pivot on shafts positioned opposite each other on the rotor. The cam followers transfers piston motion to the cam housing.
e) pivotal support for cam followers causes their attached piston to reciprocate as the rotor is caused to rotate allowing two complete pumping cycles with a single rotation of the rotor shaft, providing four pumping strokes.

9) A pump/motor according to claim 8, wherein support bearings provide at least one valve to allow intake through openings in the rotor shaft and at least one exhaust to access the cylinder.

10) A pump/motor according to claim 8, providing means to include rotary valves to provide an intake and discharge of the attached cylinder.

11) A pump/motor according to claim 8, providing means for cooling and lubricating said cylinder and working components.
